(19) United States
(12) Patent Application Publication
(10) Pub. No.: US 2009/0043884 A1
(43) Pub. Date: Feb. 12, 2009

(54) Recording Method and Recording System of Log

(75) Inventors: Yang Yu, Beijing (CN); Hui Ning, Beijing (CN); Ruining Chen, Beijing (CN); Ran Chen, Beijing (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BEIJING ACK NETWORKS, INC., Beijing (CN)

(21) Appl. No.: 12/024,048

(22) Filed: Jan. 31, 2008

(30) Foreign Application Priority Data
Aug. 9, 2007 (CN) 200710120104.6

(51) Int. Cl. G06F 15/173

(52) U.S. Cl. 709/224

(57) ABSTRACT

The present invention provides a recording method and recording system of log, the method comprising the steps of: generating an IP log, the content recorded by the IP log comprising at least an IP address and the operation being performed; finding the IP address in the IP log; replacing the found IP address with a user's information to obtain the ID log. With the present invention, the IP log is converted into ID log, in this way, the true user of the computer may be directly obtained through the ID log, the log information may provide the administrator of the system with very useful information on what is hazardous to the safety, which is significantly advantageous to the secret and security of the network of a company or an enterprise.

### CROSS-REFERENCES TO RELATED APPLICATIONS

This patent claims priority to Chinese patent application number 200710120104.6, filed Aug. 9, 2007, the disclosure of which is incorporated by reference in it entirety.

### FIELD OF THE INVENTION

The present invention relates to recording method of log, in particular, to a recording method and recording system of log.

### BACKGROUND OF THE INVENTION

To maintain the operational conditions of their system resources, computer systems typically have relevant log recording systems to record the times and time stamps, etc. of routine events or alarms of misoperation. Such log information may provide the system administrator very useful information on what is hazardous to the safety. Thus, the log finds its utility in the investigation of computer crimes.

Log is a record of network action that is temporally sequential and may contain IP addresses. What is recorded in a log file is necessary and valuable information on relevant action of IT resources, such as server, work station, firewall and application software, etc. Each log file comprises log records, each log record describing a separate system event. A log record typically comprises time of log-in, location of log-in and what operation is to be performed, etc.

For example, the log file related to a firewall shown in FIG. 1 comprises log record of 2/3/4 . . . , wherein, a log record is “Cisco-PIX-506# 192.168.1.15 2007.6.15:15:31 access 192.168.1.201 . . . ”.

Further description now is given taking a computer system as an example. For instance, facilitate the administration of the network, the accesses of all the visitors are differently defined in a company, as shown in Table 1.

TABLE 1

| | | | | Access to the | |
|---|---|---|---|---|---|
| | | | | internal | |
| ID | Name | Department | Position | server | Access to Internet |
| Wang | Xiao | Personnel | Manager | Yes | Yes |
| | Wang | | | | |
| Gao | Xiao | Personnel | Common | Yes | No |
| | Gao | | employee | | |
| Li | Xiao | Finance | Common | No | No |
| | Li | | employee | | |

To achieve the effect above, relevant schemes need to be deployed. In prior art, the control of the access is achieved based on the IP, i.e. different IP addresses are allocated to each employee and then, corresponding schemes are deployed in light of different IP addresses.

First, different IP addresses are allocated to each employee, as shown in Table 2.

TABLE 2

| Name | Computer | IP |
|---|---|---|
| Xiao Wang | PC201 | 192.168.1.8 |
| Xiao Gao | PC203 | 192.168.1.9 |
| Xiao Li | PC205 | 192.168.1.17 |

Then, each IP address is deployed with access, as shown in Table 3.

TABLE 3

| IP | Access to the internal server | Access to Internet |
|---|---|---|
| 192.168.1.8 | Yes | Yes |
| 192.168.1.9 | Yes | No |
| 192.168.1.17 | No | No |

It can be known from above that the standardized administration of the network may be achieved through the setting mentioned above in the prior art.

The above computer system may likely use the log file to record the user's time of log-in, location of log-in and what operation is to be performed, etc. and therefore, functioning as monitoring, inquiring and security auditing. The computer system shown in FIG. 2, such as Windows, Unix and Linux systems, may generate log files.

In this way, the log file and log record play an important role to some extent monitoring, inquiring, reporting and security auditing of the system. However, since the security scheme in the prior art is based on the IP address, the existing log record is IP based, and only the operational contents corresponding to a certain IP address may be reviewed in reviewing the log record. If a user operates using a computer of another one, is would be impossible to record the true user. For example, if Xiao Gao is to make access to the network or a server and uses the computer of Xiao Wang to achieve the objective, what is recorded in the log file is still, for example, “192.168.1.8 2007.7.21:11:30:05 browse web or access to server”, thus, the corresponding true user may still not be found through the network log. For example, if Xiao Gao desires to review some financial reports and uses the computer of Xiao Wang to achieve the objective, the true user may not be found through the log file, which is disadvantageous to the secret and security of the network of a company or an enterprise.

### SUMMARY OF THE INVENTION

In light of the deficiencies in the prior art above, the present invention provides a recording method and recording system of log. With the embodiments of the present invention, the true user of the computer may be found through the log record directly, which is significantly advantageous to the secret and security of the network of a company or an enterprise. Furthermore, the log based on ID (identity) may provide further valuable information.

The present invention provides a recording method of log, comprising the steps of: generating an IP log, the content recorded by the IP log comprises at least an IP address and the operation being performed; finding the IP address in the IP log; replacing the found IP address with a user's information to obtain an ID log.

The present invention provides also a recording system of log, comprising at least: an IP log generation unit for generating IP log, the content recorded by the IP log comprises at least an IP address and the operation being performed; an seek unit connected to the IP log generation unit, for receiving the IP log sent by the IP log generation unit and seeking the IP address in the IP log; and an ID log generation unit connected to the seek unit, for receiving the information on the IP address found by the seek unit as well as IP log, and replacing the found IP address with a user's information to obtain an ID log.

The advantages of the present invention are that the IP log is converted into ID log based on ID, in this way, the true user of the computer may be directly obtained through the ID log, the log information may provide the administrator of the system with very useful information on what is hazardous to the safety, which is significantly advantageous to the secret and security of the network of a company or an enterprise.

Furthermore, ID log may generate much valuable information, such as much information on the actions of human, based on which, assisting websites in introducing pertinently contents and advertisements with higher click ratio.

The ID log may serve as input for such software and hardware as log data mining and log analysis, while more exact effect may be obtained with such ID log input.

### BRIEF DESCRIPTION OF THE DRAWINGS

The accompanied drawings are provided herein for better understanding of the present invention and forming a part of this application, which should not be construed as limiting the present invention, in which:

FIG. 1 is a schematic view of the log record in the log file of the firewall based on IP in the prior art;

FIG. 2 is a schematic view of the log record in the log file of the computer system based on IP in the prior art;

FIG. 3 is a schematic view of the construction of log record system based on ID according to the embodiments of the present invention;

FIG. 4 is a flowchart of recording method of log based on ID according to the embodiments of the present invention; and

FIGS. 5A and 5B are schematic views of the ID log according to the embodiments of the present invention.

### DETAILED DESCRIPTION OF THE INVENTION

The present invention will now be further described in connection with the embodiments and the drawings for more clearly understanding of the objectives, technical solutions and advantages of the present invention. The exemplary embodiments and the description thereof are provided for explaining the present invention, rather than limiting the present invention.

An embodiment of the present invention provides a recording method and a recording system of log, the method is applicable to all the network systems deploying schemes based on ID and IP, the method comprising the steps of: generating an IP log, the content recorded by the IP log comprises at least an IP address and the operation being performed; finding the IP address in the IP log; replacing the found IP address with a user's information to obtain the ID log.

In this embodiment, the content recorded by the IP log further comprises the information on the time of using the IP address.

In this embodiment, in replacing the found IP address with the user's information, the IP address may be replaced with the user's information according to the mapping relation between the IP address and the user's information; or, the IP address may be replaced with the user's information according to the mapping relation between the IP address and the information on the time of using the IP address the user.

In this embodiment, the user's information may be user's ID or the group of the users, such as the department and position, or the group established on the basis of the ages of the users, but not limited to these, as the user's information may also be various user's information obtained upon actual demands.

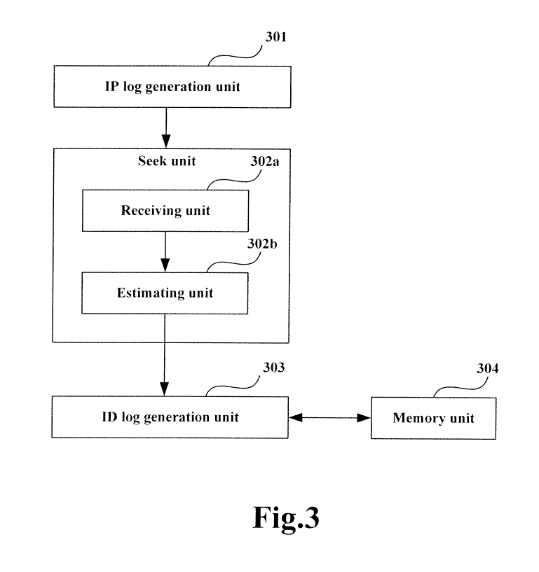

The recording method and recording system of log deploying schemes based respectively upon ID and IP will now be explained in detail, with reference to FIGS. 3, 4, 5A and 5B, taking the content recorded by the IP log including further the information on the time of using the IP address as well as replacing the IP address with the user's information according to the mapping relation between the IP address and the information on the time of using the IP address and the user as the examples.

### EXAMPLE 1

First, the recording method of log in the deployment of the schemes based upon ID will be explained, taking a computer system as an example.

The manner in which the deployment of the schemes being based upon ID will be explained first.

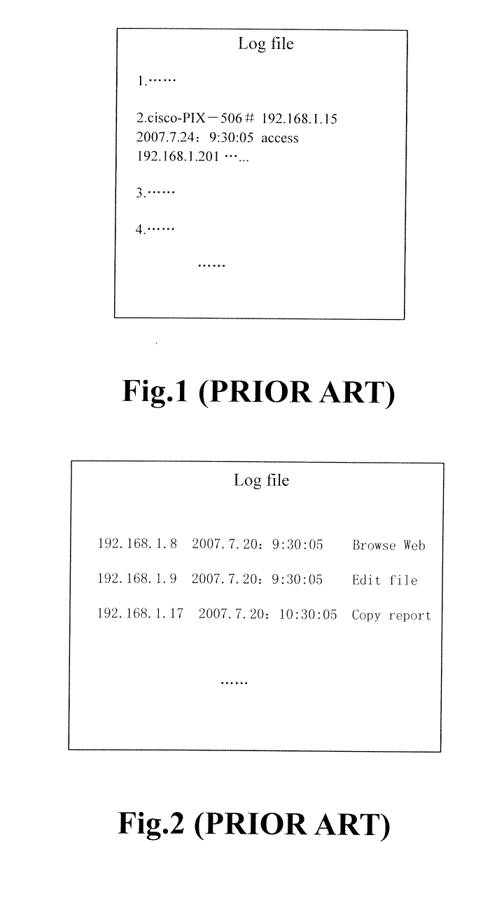

For example, to facilitate the administration of the network, a certain company or enterprise sets different access to the network for all the employees, as shown in FIG. 1.

For the manner in which the deployment of the schemes being based upon ID, the ID information and classification information corresponding to each of the employees are set first, for instance, in this embodiment, the user's ID information is shown in Table 4, and the classification information may be based upon the name and the group, such as the department or the position, as shown in Table 4.

TABLE 4

| ID | Name | Department | Position |
|---|---|---|---|
| Wang | Xiao Wang | Personnel | Manager |
| Gao | Xiao Gao | Personnel | Common employee |
| Li | Xiao Li | Finance | Common employee |

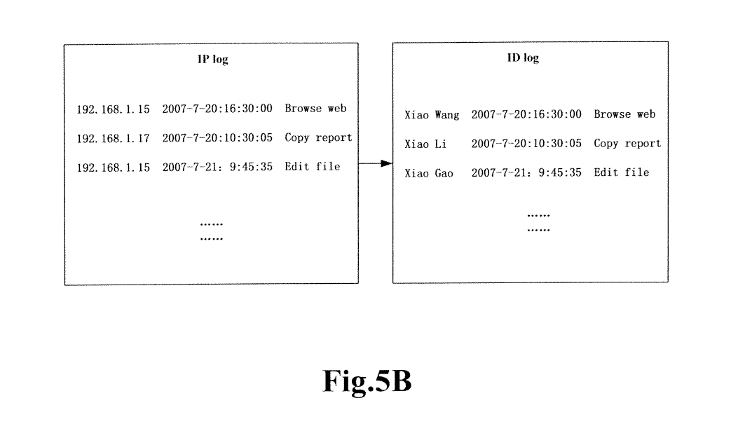

Then, the scope of the IP address being used by each of the employees is set, which may be based upon the department, the position or random combinations thereof. As shown in FIG. 5, the scope of the IP address is based upon the department. Furthermore, the set scope of the IP address may also be an IP address.

TABLE 5

| Department | IP address scope |
|---|---|
| Personnel | 192.168.1.1-192.168.1.15 |
| Finance | 192.168.1.17-192.168.1.24 |

Then, the access is set based upon the department or the position. In this embodiment, the access is set based upon the department and the position, as shown in Table 7.

TABLE 7

| | | Access to the internal | Access to |
|---|---|---|---|
| Department | Position | server | Internet |
| Personnel | Manager | Yes | Yes |
| Personnel | Common employee | Yes | No |
| Finance | Common employee | No | No |

Thus, when one of the employees, such as Xiao Wang, logs in a certain terminal via ID, the server, after the authentication is pass, allocates an IP address to Xiao Wang according to Xiao Wang's ID, i.e. the mapping relations with Wang in tables 4 and 5, the IP address allocated to Xiao Wang may be one of 192.168.1.1-192.168.1.15, such as 192.168.1.15. However, it may not be limited to the manner mentioned above. If Xiao Wang is the manager of the department of personnel, not a common employee, an IP address scope may be separately defined for the manager of the department of personnel to insure more accesses of the manager, such as 192.168.1.16.

Then, the allocated IP address and the ID of the user are recorded in a IP-ID mapping table, such as shown in Table 8, meanwhile, the time of log-in of the user is also recorded.

TABLE 8

| ID | IP | Time of start | Time of termination |
|---|---|---|---|
| Wang | 192.168.1.15 | 16:30:00 7-20-2007 | 17:00:00 7-20-2007 |
| Gao | 192.168.1.9 | 8:00:30 7-20-2007 | 17:00:00 7-20-2007 |
| Li | 192.168.1.17 | 10:30:05 7-20-2007 | 12:30:00 7-20-2007 |
| Gao | 192.168.1.15 | 9:45:35 7-21-2007 | 11:15:00 7-21-2007 |

In this embodiment, as shown in Table 8, the same IP address, such as 192.168.1.15, may be allocated in different times to different users, such as “Wang” and “Gao”. Thus, in converting an IP log into an ID log, the time may be taken as a parameter, making the converted ID more efficient.

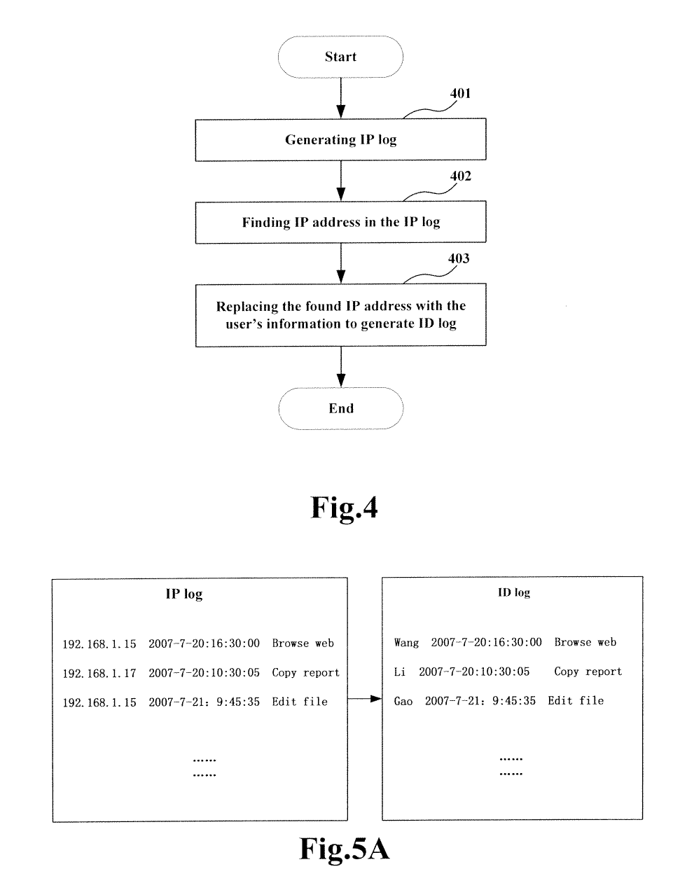

The recording method of log of the embodiment of the present invention based upon ID will now be explained in detail, with reference to FIGS. 4, 5A and 5B.

The present invention provides a recording method of log, as shown in FIGS. 4, 5A and 5B, comprising the steps of:

Step 401, generating an IP log, the content recorded by the IP log comprises at least an IP address, the time of using the IP address and the operation being performed, as shown in FIGS. 5A and 5B, it may not be limited to this, since the IP log may comprise no time information, and any other information may be recorded as desired.

Step 402, finding the IP address in the generated IP log; wherein, the following way may be employed in finding the IP address: estimating a dot, i.e. estimating whether there are at least three dot characters in the content recorded in the IP log, wherein, for IP4, the IP address contains three dot characters “.”. If there is “.”, further estimating whether the information “*” between two adjacent characters “.*.” in the at least three dot characters “.” is a digit; if it is estimated that the “*” is a digit, determining the information adjacent to the at least three dot characters and said dot character, for example, * form an IP address, thus, an IP address is found.

For example, for IPv4, such as 192.168.1.15, when the content of the log is reviewed, estimating first whether three “.” are contained, for the said IP address, three “.” are contained, then estimation whether the information between two adjacent characters “.” is a digit, for the said IP address, the information “168” and “1” between two adjacent characters “.” are digits, thus, it is estimated that the information adjacent to these three “.” and these three “.” form an IP address, i.e. 192.168.1.15.

In this embodiment, such digits are within the range of 0-255.

Step 403, after the IP address is found, replacing the IP address with the ID according to mapping relation between the IP address, the time of using the IP address and the ID, for example, if the IP address is 192.168.1.15 and the time is 16:30:00 7-20-2007, the IP address will be replaced with “Wang” according to Table 8, as shown in FIG. 5A; furthermore, for the same IP address, when the time is 9:45:35 7-21-2007, which corresponding to the ID of “Gao” in Table 8, the IP address will be replaced with “Gao”. Likewise, if the IP address allocated to Xiao Li is 192.168.1.17 and the time is 10:30:05 7-20-2007, the IP address will be replaced with “Li”.

Alternatively, the IP address may be replaced with “Xiao Wang” according to the mapping relation between the ID and the name, as shown in Table 4, to obtain the ID log, as shown in FIG. 5B.

Furthermore, the recording method of log deploying schemes based upon IP is similar to that based upon ID.

For example, when Xiao Wang logs in a certain terminal via ID, the server, after the authentication is pass, allocates an IP address to Xiao Wang according to the mapping relations with Wang in tables 1, 2 and 3, that is 192.168.1.8. Then, the allocated IP address and the ID of the user are recorded in a IP-ID mapping table, generating of mapping relation table as shown in FIG. 9, meanwhile, the time of start and termination of log-in of the user are also recorded.

TABLE 9

| ID | IP | Time of start | Time of termination |
|---|---|---|---|
| Wang | 192.168.1.8 | 16:30:00 7-20-2007 | 17:00:00 7-20-2007 |
| Gao | 192.168.1.9 | 8:00:30 7-20-2007 | 17:00:00 7-20-2007 |
| Li | 192.168.1.17 | 10:30:05 7-20-2007 | 12:30:00 7-20-2007 |
| Gao | 192.168.1.8 | 9:45:35 7-21-2007 | 11:15:00 7-21-2007 |

In the recording method of log deploying schemes based upon IP, the procedure for converting the IP log into ID log is similar to that based upon ID. After the IP address is found, replacing the IP address with the ID according to mapping relation between the IP address, the time of using the IP address and the ID, as shown in Table 9, for example, if the IP address is 192.168.1.8, the IP address will be replaced with “Wang” or “Gao” according to Table 9, as shown in FIG. 5A; likewise, if the IP address is 192.168.1.17, the IP address may be replaced with “Li”. It may be known from above that, if Xiao Gao is to make access to the network or a server and uses the computer of Xiao Wang to achieve the objective, the true user may be known from the ID log file and therefore, it is advantageous to the administration of the network and the security of the network.

Likewise, in the above embodiment, the mapping relation between the IP and the group of user, such as IP-department and IP-position, may be obtained according to the ID of the user and mapping relations in tables 4, 5 and 9, as well as the mapping relation in tables 1, 2, 3 and 9; furthermore, the user group may be based on the age of the users, but not limited to this, as the above mapping relations may be in accordance with actual situations and the user information to be obtained.

With the embodiment above, the IP log is converted into ID log based on ID, in this way, the true user of the computer may be directly obtained through the ID log, the log information may provide the administrator of the system with very useful information on what is hazardous to the safety, which is significantly advantageous to the secret and security of the network of a company or an enterprise.

For a website, an ID log may create many useful valuable information, such as much information on the actions of human obtained through the analysis by the ID log, based on which, assisting websites in introducing pertinently contents and advertisements with higher click ratio; furthermore, the ID log may serve as input for such software and hardware as log data mining and log analysis, while more exact effect may be obtained with such ID log input.

### EXAMPLE 2

The present invention provides also a recording system of log, as shown in FIG. 3, comprising at least: an IP log generation unit 301 for generating IP log, the content recorded by the IP log comprises at least an IP address and the operation being performed; furthermore, the IP log may comprise such information as time, etc., but not limited to this; an seek unit 302 connected to the IP log generation unit 301, for receiving the IP log sent by the IP log generation unit 301 and seeking the IP address in the IP log; and an ID log generation unit 303 connected to the seek unit, for receiving the information on the IP address found by the seek unit 302 as well as IP log, and replacing the found IP address with a user's information to obtain the ID log.

In this embodiment, the ID log generation unit 303 replaces the IP address with the user's information according to the mapping relation between the time of the IP address and the ID, but it may not be limited to this, the ID log generation unit 303 may also replace the IP address with the user's information according to the mapping relation between the IP address and the ID.

In this embodiment, the seek unit 302 comprises at least: a receiving unit 302a connected to the IP log generation unit 301, for receiving the IP log sent by the IP log generation unit 301; and an estimating unit 302b connected to the receiving unit 302a, for estimating whether there are at least three dot characters in the IP log; if yes, further estimating whether the information between two adjacent characters in the at least three dot characters is a digit; if yes, determining the information adjacent to the at least three dot characters and said dot character, for example, *.*.*.* form an IP address, and transmitting the IP address and the IP log to the ID log generation unit 303.

Furthermore, the system shown in FIG. 3 comprises a memory unit 304 connected to the ID log generation unit 303, for memorizing the generated ID log.

The embodiment above is described taking the format of the log being the log file as the example, but it may not be limited to this, besides log file, the ID log may also be the format of item-to-item log record, the processing procedure for which is similar to that of log file, and shall not be described further.

The operational procedures of the system is in consistent with that in the method and shall not be described further.

With the embodiment above, the IP log is converted into ID log based on ID, in this way, the true user of the computer may be directly obtained through the ID log, the log information may provide the administrator of the system with very useful information on what is hazardous to the safety, which is significantly advantageous to the secret and security of the network of a company or an enterprise.

Additionally, for a website, an ID log may create many useful valuable information, such as much information on the actions of human obtained through the analysis by the ID log, based on which, assisting websites in introducing pertinently contents and advertisements with higher click ratio; furthermore, the ID log may serve as input for such software and hardware as log data mining and log analysis, while more exact effect may be obtained with such ID log input.

The objectives, technical solutions and advantageous effects of the present invention are described above with reference to the embodiments, however, it should be understood that these embodiments are exemplary and not for limiting the scope of the present invention. Any modification, alternatives and variations made without departing from the spirits and scope of the present invention shall be deemed as falling within the scope of the present invention.

What is claimed is:

1. A method for log recording comprising:
generating an IP log, the content recorded by the IP log comprises at least an IP address and the operation being performed;
finding the IP address in the IP log; and
replacing the found IP address with a user's information to obtain an ID log.

2. The method of claim 1, wherein the content recorded by the IP log further comprising information on the time of using the IP address.

3. The method of claim 1, wherein the found IP address may be replaced with the user's information according to a mapping relation between the IP address and the user's information.

4. The method of claim 2, wherein the found IP address may be replaced with the user's information according to a mapping relation between the IP address and the information on the time of using the IP address and the user.

5. The method of claim 1, wherein finding the IP address in the IP log comprising:
estimating whether there are at least three dot characters in the content recorded by the IP log;
if yes, further estimating whether the information between two adjacent characters in the at least three dot characters is a digit; and
if yes, determining the information adjacent to the at least three dot characters and said dot character form an IP address.

6. The method of claim 5, wherein the digits are within the range of 0-255.

7. The method of claim 1, wherein the user's information includes at least one of the user's ID, the true name of the user, a group, department and position of the user.

8. The method of claim 2, wherein the user's information includes at least one of the user's ID, the true name of the user, a group, department and position of the user.

9. The method of claim 1, wherein the IP log and the ID log may be in the format of log file or item-to-item log record.

10. A system for log recording comprising:
an IP log generation unit for generating IP log, the content recorded by the IP log comprises at least an IP address and the operation being performed;
a seek unit connected to the IP log generation unit, for receiving the IP log sent by the IP log generation unit and seeking the IP address in the IP log; and
an ID log generation unit connected to the seek unit, for receiving the information on the IP address found by the seek unit as well as IP log, and replacing the found IP address with a user's information to obtain an ID log.

11. The system of claim 10, wherein the content recorded by the IP log further comprising information on the time of using the IP address.

12. The system of claim 10, wherein the ID log generation unit replaces the found IP address with the user's information according to a mapping relation between the IP address and the user's information.

13. The system of claim 11, wherein the ID log generation unit replaces the found IP address with the user's information according to a mapping relation between the IP address and the information on the time of using the IP address and the user.

14. The system of claim 10, wherein the seek unit comprising:
a receiving unit connected to the IP log generation unit, for receiving the IP log sent by the IP log generation unit; and
an estimating unit connected to the receiving unit, for estimating whether there are at least three dot characters in the IP log; if yes, further estimating whether the information between two adjacent characters in the at least three dot characters is a digit; if yes, determining the information adjacent to the at least three dot characters and said dot character form an IP address, and transmitting the IP address and the IP log to the ID log generation unit.

15. The system of claim 11, wherein the seek unit comprising:
a receiving unit connected to the IP log generation unit, for receiving the IP log sent by the IP log generation unit; and
an estimating unit connected to the receiving unit, for estimating whether there are at least three dot characters in the IP log; if yes, further estimating whether the information between two adjacent characters in the at least three dot characters is a digit; if yes, determining the information adjacent to the at least three dot characters and said dot character form an IP address, and transmitting the IP address and the IP log to the ID log generation unit.

16. The system of claim 14, wherein the digits are within the range of 0-255.

17. The system of claim 15, wherein the digits are within the range of 0-255.

18. The system of claim 10, further comprising a memory unit connected to the ID log generation unit, for memorizing the generated ID log.

19. The system of claim 10, wherein the user's information includes at least one of the user's ID, the true name of the user, a group, department and position of the user.

20. The system of claim 11, wherein the user's information includes at least one of the user's ID, the true name of the user, a group, department and position of the user.
